(19) United States
(12) Patent Application Publication
(10) Pub. No.: US 2013/0085845 A1
(43) Pub. Date: Apr. 4, 2013

(54) FACILITATING DEAL COMPARISON AND ADVERTISING IN ASSOCIATION WITH EMAILS

(71) Applicant: Jianchang Mao, San Jose, CA (US)

(72) Inventor: Jianchang Mao, San Jose, CA (US)

(73) Assignee: Yahoo! Inc., Sunnyvale, CA (US)

(21) Appl. No.: 13/252,471

(22) Filed: Oct. 4, 2011

(51) Int. Cl. G06Q 30/02

(52) U.S. Cl. 705/14.49

(57) ABSTRACT

Techniques are provided which improve deal and advertisement targeting of users, and which may include facilitating user comparison of deals. Methods and systems may detect if an email contains deal information related to one or more deals. If an email contains deal information, the deal information may be extracted. When the email is opened by the user, a link may be displayed on top of (e.g., overlaid on) the email. The link may be configured such that clicking on the link transmits a search query comprising the extracted deal information to a deal service. The deal service may retrieve one or more additional deals which may be similar or related to the one or more deals received in the email. The additional deals may be selected by the deal service based at least in part on the extracted deal information.

### BACKGROUND

In recent years, online deals marketplaces and services that leverage group buying have significantly increased in popularity. Many of these marketplaces and services send their daily deals via emails to users who subscribe to the service. The daily emails are typically sent to users who are local to the merchants providing the product or service being advertised. However, the deals are not well targeted to the users' interests or needs. This results in the users receiving a lot of unwanted deals in their email inbox. In addition, the deals marketplaces and services attempt to increase traffic to their sites by attracting users through advertising campaigns.

There is a need for techniques in online advertising relating to, among other things, improving deals/ad targeting and distribution, and for increasing traffic to deal marketplaces and sites.

### SUMMARY

Some embodiments of the invention provide systems and methods which allow improved deal and advertisement targeting. In some embodiments, it is detected if an email addressed to a user comprises deal information related to one or more deals. Deal information may include, for example, one or more of location information, merchant information, price information, discount information, and information related to a type of product or service being advertised in the one or more deals. In some embodiments, if the email is detected to comprise deal information, the email may be flagged.

The deal information may be extracted if the email is detected to comprise deal information. A link may be displayed in the email when the email is opened by the user. In one embodiment, the link may be configured such that clicking the link may cause a search query comprising the extracted deal information to be transmitted to a deal service, and may direct the user's browser application to the deal service website. The link may be displayed on top of the email. In other words, the link may be overlaid on top of the email such that the body of the email is not modified in order to display the link. In one embodiment the link may be a graphical link (e.g., a button). Alternatively, the link may be a text link. In accordance with an exemplary embodiment, the deal service may be, for example, a deals marketplace (e.g., deals.yahoo.com). Alternatively, the deal service may be a search engine. In accordance with an exemplary embodiment, the deal service may retrieve one or more deals which are similar or related to the one or more deals presented in the email based at least in part on the extracted deal information. In some embodiments, after being directed to the deal service website, the user may be allowed to modify one or more parameters of the search query in order to customize the search for similar or related deals.

In some embodiments, it is detected if an email addressed to a user comprises deal information related to one or more deals. The deal information may be extracted if the email is detected to comprise deal information.

It is detected if the user clicked on a link in the email. The link may be, for example, a link that directs the user to a merchant's website to get further details about the deal.

If the user clicked the link, one or more additional deals which are similar or related to the one or more deals based at least in part on the extracted deal information may be selected. For example, if the email contained a deal for an auto detailing shop in San Jose, Calif. offering its services for 50% off, one or more deals for other auto detailing shops in San Jose may be selected. Alternatively, or in addition, one or more deals for other auto detailing shops which may be located outside of San Jose but may be offering a greater than 50% discount may be selected. The one or more additional deals may be targeted to the user. In one embodiment, an email may be generated including the one or more additional deals, and the email may be sent to the user. In other embodiments, the one or more additional deals may be presented to the user in the user's browser application. In some embodiments, one or more advertisements related to the one or more deals may be selected. The one or more advertisements may then be served to the user via an email or in the user's browser application.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a block diagram illustrating one embodiment of the invention;

FIG. 6 is a flow diagram illustrating a method according to one embodiment of the invention;

FIG. 7 is a flow diagram illustrating a method according to one embodiment of the invention; and

FIG. 8 is a block diagram illustrating one embodiment of the invention.

### DETAILED DESCRIPTION

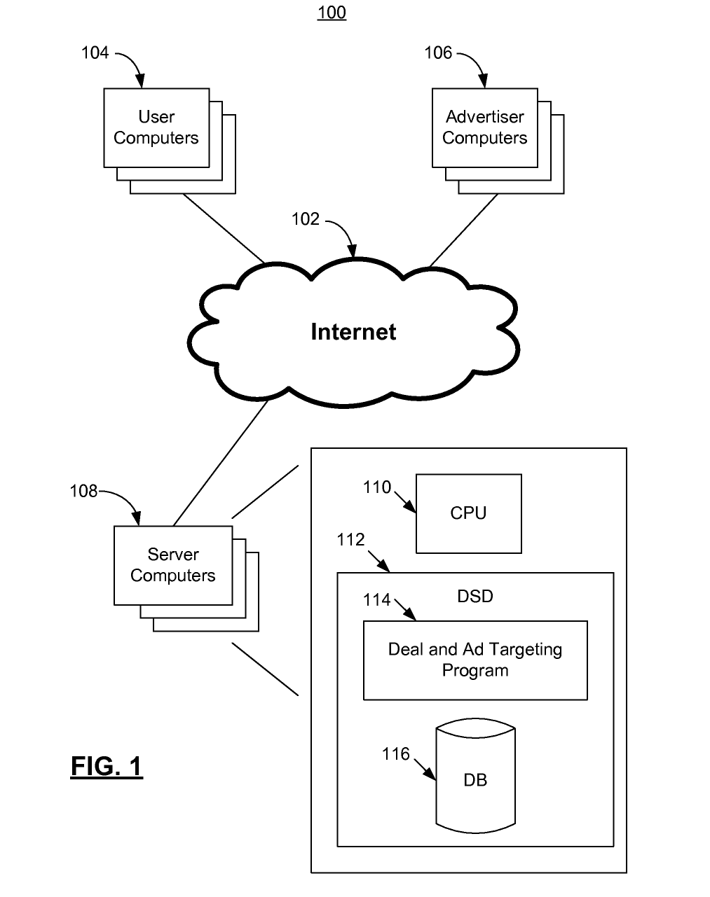

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Deal and Ad Targeting Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

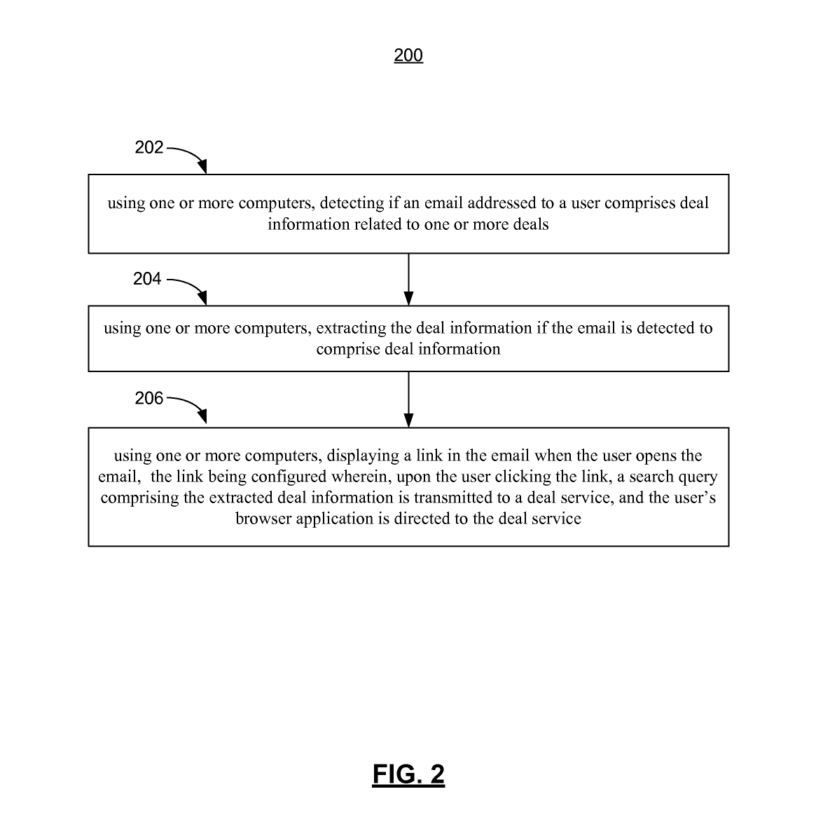

FIG. 2 is a flow diagram illustrating a method 200 according to one embodiment of the invention. At step 202 using one or more computers, it is detected if an email addressed to a user comprises deal information related to one or more deals. For example, one or more server computers 108 (FIG. 1), which may be configured as email servers, may determine when the email arrives if the email comprises deal information related to one or more deals. Deal information may include, for example, one or more of location information, merchant information, price information, discount information, and information related to a type of product or service being advertised in the one or more deals. In some embodiments, if the email is detected to comprise deal information, the email may be flagged. In some embodiments, an email may be determined to comprise deal information if it is a confirmation email, such as for example, an email received after a purchase is made. In addition, an email may also be determined to comprise deal information if it includes, for example, one or more coupons or discount codes.

At step 204, using one or more computers, the deal information may be extracted if the email is detected to comprise deal information. In one embodiment, one or more server computers 108 (FIG. 1) may extract the deal information when the email arrives in the user's inbox. In other embodiments, one or more server computers 108 (FIG. 1) may extract the deal information when the user opens the email.

At step 206 using one or more computers, a link may be displayed in the email when the email is opened by the user. In one embodiment, the link may be configured such that clicking the link may cause a search query comprising the extracted deal information to be transmitted to a deal service, and may direct the user's browser application to the deal service website. The link may be displayed on top of the email. In other words, the link may be overlaid on top of the email such that the body of the email is not modified in order to display the link. In one embodiment the link may be a graphical link (e.g., a button). Alternatively, the link may be a text link. In accordance with an exemplary embodiment, the deal service may be, for example, a deals marketplace (e.g., deals.yahoo.com). Alternatively, the deal service may be a search engine. In accordance with an exemplary embodiment, the deal service may retrieve one or more deals which are similar or related to the one or more deals presented in the email based at least in part on the extracted deal information. For example, if the email contained a deal for an auto detailing shop in San Jose, Calif. offering its services for 50% off, the deal service may retrieve one or more deals for other auto detailing shops in San Jose. Alternatively, or in addition, the deal service may retrieve one or more deals for other auto detailing shops which may be located outside of San Jose but may be offering a greater than 50% discount. In another example, the deal service may retrieve one or more deals for autoparts. In some embodiments, the deal service (e.g., deal marketplace or search engine) may aggregate the extracted deal information received from users and present the corresponding deals as part of the search results to increase coverage and depth of deals. Alternatively, or in addition, the deal service may allow paid inclusion of deals from other deals sites or marketplaces in the search results. Using the above example, other deal sites may pay the deal service to have their deals included in the search results for deals which are similar or related to the auto detailing shop deal. In some embodiments, the deal service may charge the other deal sites or marketplaces on a cost per lead or cost per action basis.

In some embodiments, after being directed to the deal service website, the user may be allowed to modify one or more parameters of the search query in order to customize the search for similar or related deals.

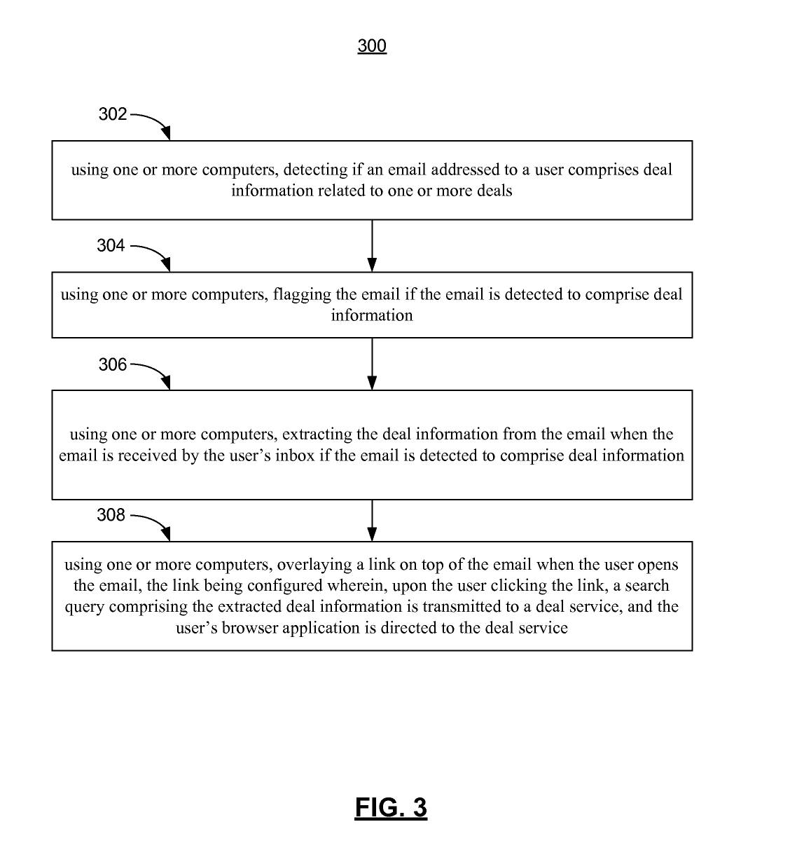

FIG. 3 is a flow diagram illustrating a method 300 according to one embodiment of the invention. At step 302, using one or more computers, it is detected if an email addressed to a user comprises deal information related to one or more deals.

At step 304, using one or more computers, if the email is detected to comprise deal information, the email is flagged.

At step 306, using one or more computers, if the email is detected to comprise deal information, the deal information may be extracted from the email when the email is received by the user's inbox.

At step 308, using one or more computers, a link may be overlaid on top of the email when the user opens the email. In one embodiment the link may be a graphical link (e.g., a button). Alternatively, the link may be a text link. The link may be configured such that clicking the link may cause a search query comprising the extracted deal information to be transmitted to a deal service, and may direct the user's browser application to the deal service website.

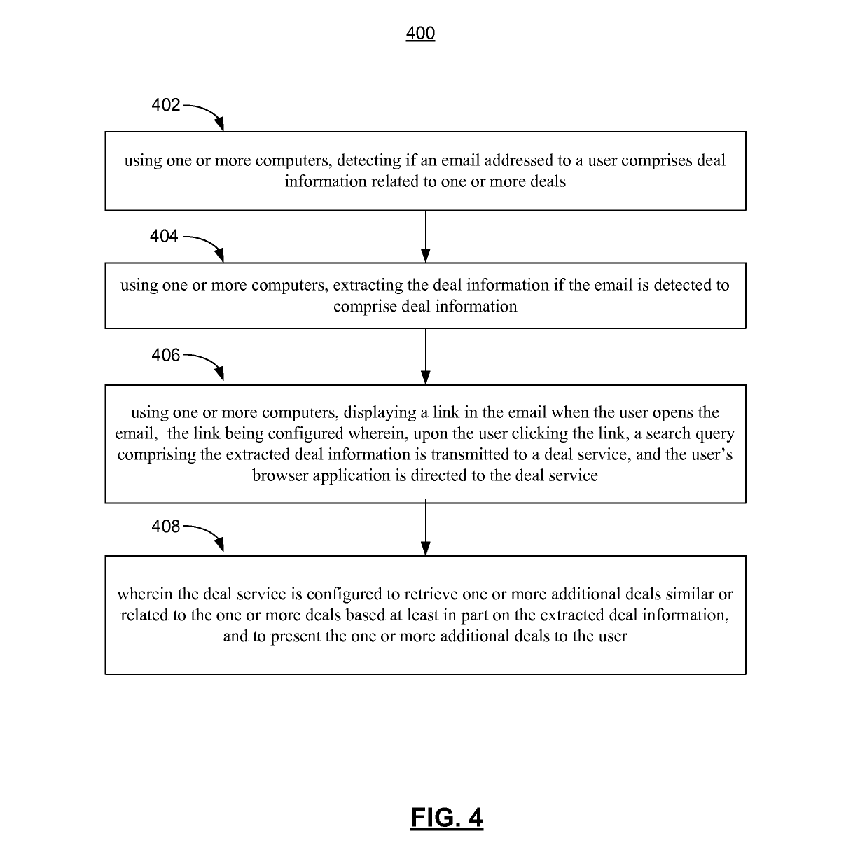

FIG. 4 is a flow diagram illustrating a method 400 according to one embodiment of the invention. At step 402 using one or more computers, it is detected if an email addressed to a user comprises deal information related to one or more deals. Deal information may include, for example, one or more of location information, merchant information, price information, discount information, and information related to a type of product or service being advertised in the one or more deals. In some embodiments, if the email is detected to comprise deal information, the email may be flagged.

At step 404, using one or more computers, the deal information may be extracted if the email is detected to comprise deal information.

At step 406, using one or more computers, displaying a link in the email when the user opens the email. In one embodiment the link may be a graphical link (e.g., a button). Alternatively, the link may be a text link. The link may be configured such that clicking the link may cause a search query comprising the extracted deal information to be transmitted to a deal service, and may direct the user's browser application to the deal service website. At step 408, deal service may retrieve one or more additional deals which are similar or related to the one or more deals presented in the email based at least in part on the extracted deal information, and the deal service may present the one or more additional deals to the user (e.g., in the user's browser application).

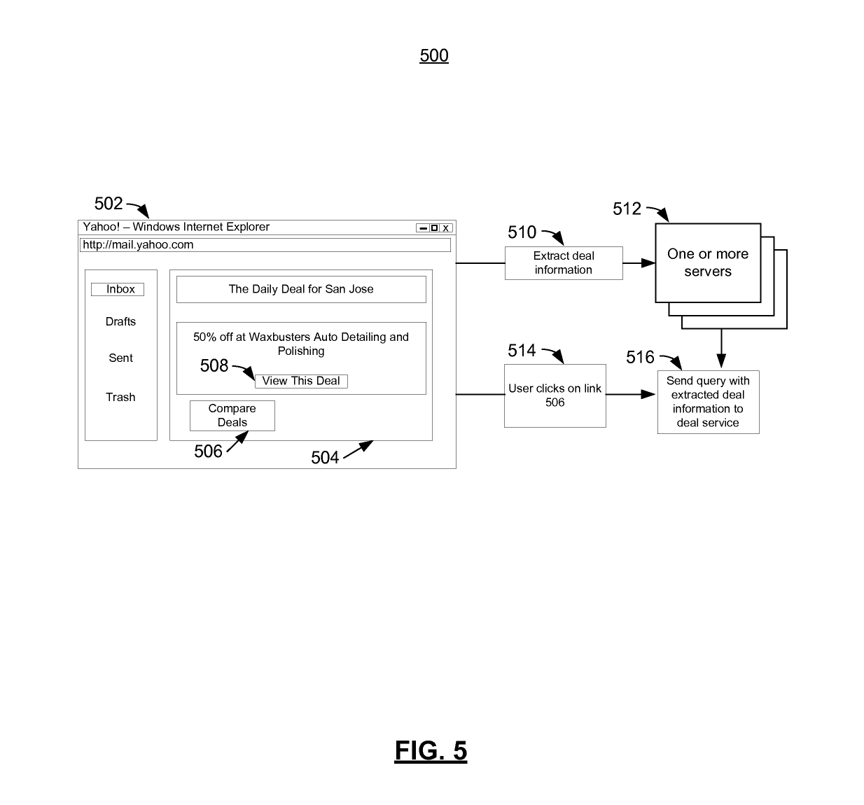

FIG. 5 is a block diagram 500 illustrating one embodiment of the invention. An exemplary webpage 502 is displayed in a browser application. An exemplary email 504 is displayed in webpage 502. Email 504 includes deal information such as the location (San Jose), merchant information (Waxbusters), discount information (50% off), and information on the type of product or service (auto detailing). It should be noted that email 504 is but one example, and an email may comprise any other information related to a deal (e.g., expiration date). In some embodiments, an email may be determined to comprise deal information if it is a confirmation email, such as for example, an email received after a purchase is made. An email may also be determined to comprise deal information if it includes, for example, one or more coupons or discount codes. In addition, email 504 may include a link 508. Link 508, which may be a text or graphical link, may direct the user's browser application to the merchant's website (e.g., Waxbusters) or to another site where the user may obtain additional information related to the deal. If email 504 is detected to include deal information, the deal information may be extracted by one or more servers 512, as depicted in block 510. One or servers 512 may include an email server. The extracted deal information may also be stored on one or more servers 512. The deal information may be extracted by one or more servers 512 when email 504 is received by the user's inbox (e.g., at the email server). When email 504 is opened by the user, a link 506 may be displayed on top of email 504. In other words, link 506 may be overlaid on top of email 504. Although link 506 is shown as a graphical link in FIG. 5 (e.g., a button), it may be a text link.

If the user clicks on link 506, as depicted in block 514, a query with the extracted deal information may be sent to a deal service, as depicted in block 516. In accordance with an exemplary embodiment, the deal service may be, for example, a deals marketplace (e.g., deals.yahoo.com). Alternatively, the deal service may be a search engine. In accordance with an exemplary embodiment, the deal service may retrieve one or more deals which are similar or related to the one or more deals presented in the email based at least in part on the extracted deal information. For example, if the email contained a deal for an auto detailing shop in San Jose, Calif. offering its services for 50% off, the deal service may retrieve one or more deals for other auto detailing shops in San Jose. Alternatively, or in addition, the deal service may retrieve one or more deals for other auto detailing shops which may be located outside of San Jose but may be offering a greater than 50% discount. In some embodiments, the deal service (e.g., deal marketplace or search engine) may aggregate the extracted deal information received from users and present the corresponding deals as part of the search results to increase coverage and depth of deals. Alternatively, or in addition, the deal service may allow paid inclusion of deals from other deals sites or marketplaces in the search results. Using the above example, other deal sites may pay the deal service to have their deals included in the search results for deals which are similar or related to the auto detailing shop deal. In some embodiments, the deal service may charge the other deal sites or marketplaces on a cost per lead or cost per action basis.

In some embodiments, after being directed to the deal service website, the user may be allowed to modify one or more parameters of the search query in order to customize the search for similar or related deals. For example, the user may wish to search for similar or related deals outside of San Jose and may modify the query accordingly.

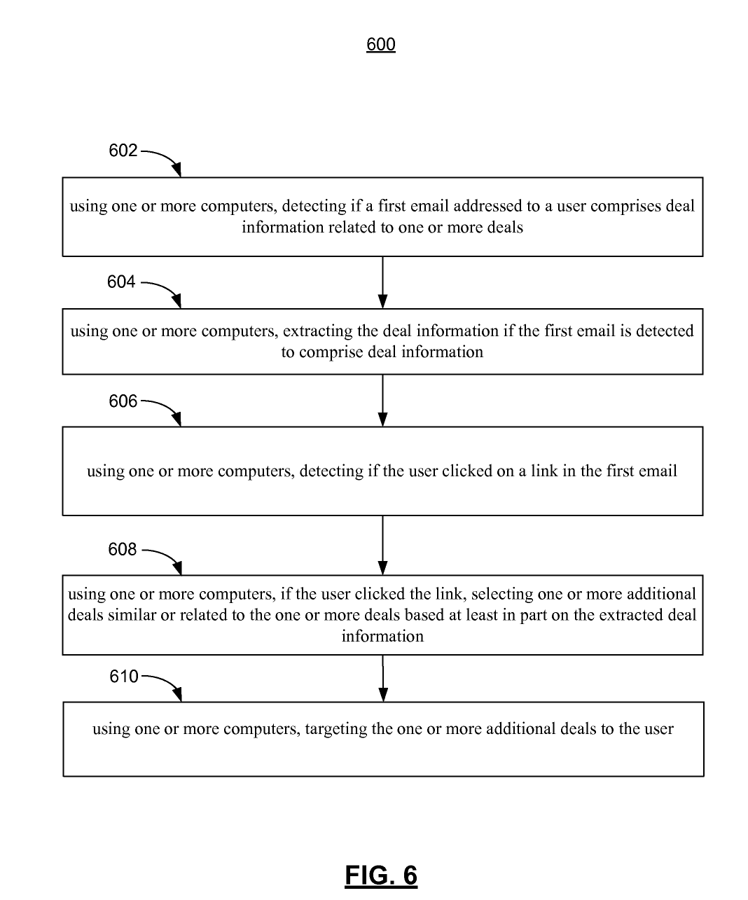

FIG. 6 is a flow diagram illustrating a method 600 according to one embodiment of the invention. At step 602 using one or more computers, it is detected if an email addressed to a user comprises deal information related to one or more deals. For example, one or more server computers 108 (FIG. 1), which may be configured as email servers, may determine when the email arrives if the email comprises deal information related to one or more deals. Deal information may include, for example, one or more of location information, merchant information, price information, discount information, and information related to a type of product or service being advertised in the one or more deals. In some embodiments, an email may be determined to comprise deal information if it is a confirmation email, such as for example, an email received after a purchase is made. In addition, an email may also be determined to comprise deal information if it includes, for example, one or more coupons or discount codes. In some embodiments, if the email is detected to comprise deal information, the email may be flagged.

At step 604, using one or more computers, the deal information may be extracted if the email is detected to comprise deal information. In one embodiment, one or more server computers 108 (FIG. 1) may extract the deal information when the email arrives in the user's inbox (e.g., arrives at the email server). In other embodiments, one or more server computers 108 (FIG. 1) may extract the deal information when the user opens the email.

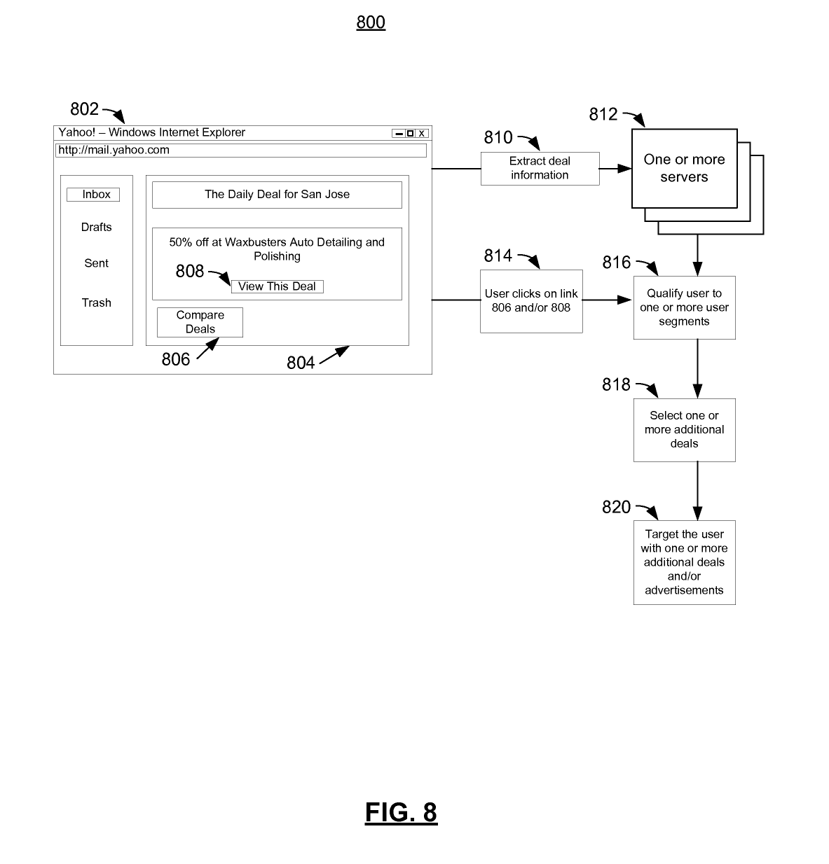

At step 606, using one or more computers, it is detected if the user clicked on a link in the email. The link may be, for example, a link that directs the user to a merchant's website to get further details about the deal. Using the exemplary embodiment of FIG. 8, the link may be link 808. Alternatively, the link may be a “Compare Deals” link (e.g., link 806 in FIG. 8).

At step 608, using one or more computers, if the user clicked the link, one or more additional deals which are similar or related to the one or more deals based at least in part on the extracted deal information may be selected. For example, if the email contained a deal for an auto detailing shop in San Jose, Calif. offering its services for 50% off, one or more deals for other auto detailing shops in San Jose may be selected. Alternatively, or in addition, one or more deals for other auto detailing shops which may be located outside of San Jose but may be offering a greater than 50% discount may be selected. In some embodiments, the extracted deal information received from users may be aggregated and the corresponding deals may be selected to increase coverage and depth of deals. Alternatively, or in addition, paid inclusion of deals from other deals sites or marketplaces may be allowed. Using the above example, other deal sites may be charged to have their deals included in the results for deals which are similar or related to the auto detailing shop deal. In some embodiments, the other deal sites or marketplaces may be charged on a cost per lead or cost per action basis. At step 610, using one or more computers, the one or more additional deals may be targeted to the user. In one embodiment, an email may be generated including the one or more additional deals, and the email may be sent to the user. In other embodiments, the one or more additional deals may be presented to the user in the user's browser application.

In some embodiments, one or more advertisements related to the one or more deals may be selected. The one or more advertisements may then be served to the user via an email or in the user's browser application. For example, the advertisements may be served to the user in the browser application when the user visits other websites.

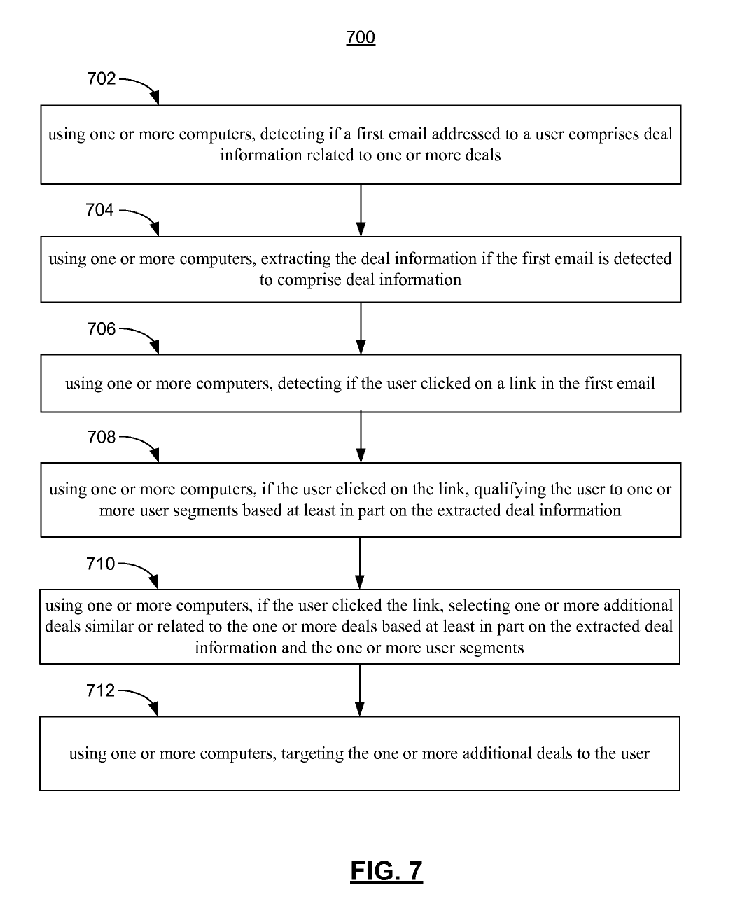

FIG. 7 is a flow diagram illustrating a method 600 according to one embodiment of the invention. At step 702 using one or more computers, it is detected if an email addressed to a user comprises deal information related to one or more deals. For example, one or more server computers 108 (FIG. 1), which may be configured as email servers, may determine when the email arrives if the email comprises deal information related to one or more deals. Deal information may include, for example, one or more of location information, merchant information, price information, discount information, and information related to a type of product or service being advertised in the one or more deals. In some embodiments, if the email is detected to comprise deal information, the email may be flagged.

At step 704, using one or more computers, the deal information may be extracted if the email is detected to comprise deal information. In one embodiment, one or more server computers 108 (FIG. 1) may extract the deal information when the email arrives in the user's inbox (e.g., arrives at the email server). In other embodiments, one or more server computers 108 (FIG. 1) may extract the deal information when the user opens the email.

At step 706, using one or more computers, it is detected if the user clicked on a link in the email. The link may be, for example, a link that directs the user to a merchant's website to get further details about the deal. Using the exemplary embodiment of FIG. 8, the link may be link 808.

At step 708, using one or more computers, if the user clicked the link, the user may be qualified to one or more user segments based at least part on the extracted deal information. In some embodiments, user clicks and the corresponding extracted deal information may be aggregated to create one or more user segments. Some embodiments of the invention advantageously allow the user's intent to be inferred from the user interaction with the email including one or more deals. For example, if the email contained a deal for an auto detailing shop in San Jose, Calif. offering its services for 50% off, and the user clicked on the “view this deal” link, it may be inferred that the user is interested in deals for automobile services. At step 710, using one or more computers, if the user clicked the link, one or more additional deals similar or related to the one or more deals included in the email may be selected based at least in part on the extracted deal information and the one or more user segments. At step 712, using one or more computers, the one or more additional deals may be targeted to the user. In one embodiment, an email may be generated including the one or more additional deals, and the email may be sent to the user. In other embodiments, the one or more additional deals may be presented to the user in the user's browser application.

In some embodiments, one or more advertisements related to the one or more deals may be selected. The one or more advertisements may then be served to the user via an email or in the user's browser application. For example, the advertisements may be served to the user in the browser application when the user visits other websites.

FIG. 8 is a block diagram 800 illustrating one embodiment of the invention. An exemplary webpage 802 is displayed in a browser application. An exemplary email 804 is displayed in webpage 802. Email 804 includes deal information such as the location (San Jose), merchant information (Waxbusters), discount information (50% off), and information on the type of product or service (auto detailing). It should be noted that email 804 is but one example, and an email may comprise any other information related to a deal (e.g., expiration date). In addition, email 804 may include a link 808. Link 808, which may be a text or graphical link, may direct the user's browser application to the merchant's website (e.g., Waxbusters) or to another site where the user may obtain additional information related to the deal. When email 804 is opened by the user, a link 806 may be displayed on top of email 804. In other words, link 806 may be overlaid on top of email 804. Although link 806 is shown as a graphical link (e.g., a button), it may be a text link. If email 804 is detected to include deal information, the deal information may be extracted by one or more servers 812, as depicted in block 810. In some embodiments, an email may be determined to comprise deal information if it is a confirmation email, such as for example, an email received after a purchase is made. In addition, an email may also be determined to comprise deal information if it includes, for example, one or more coupons or discount codes. One or servers 812 may include an email server. The extracted deal information may also be stored on one or more servers 812. The deal information may be extracted by one or more servers 812 when email 804 is received by the user's inbox (e.g., at the email server).

If the user clicks on link 806 and/or 808, as depicted in block 814, the user may be qualified to one or more user segments based at least in part on the extracted deal information, as depicted in block 816. For example, if the user clicks on link 808, it may be inferred that the user is interested in deals for automobile services. In some embodiments, user clicks and the corresponding extracted deal information may be aggregated to create one or more user segments. As depicted in block 818, one or more additional deals may be selected based at least in part on the extracted deal information and the one or more user segments. For example, if the email contained a deal for an auto detailing shop in San Jose, Calif. offering its services for 50% off, the deal service may retrieve one or more deals for other auto detailing shops in San Jose. Alternatively, or in addition, the deal service may retrieve one or more deals for other auto detailing shops which may be located outside of San Jose but may be offering a greater than 50% discount. In some embodiments, one or more advertisements related to the one or more deals may also be selected based at least in part on the extracted deal information and/or the user segments.

As depicted in block 820, the one or more additional deals and/or advertisements may be targeted to the user. In one embodiment, an email may be generated including the one or more additional deals and/or advertisements, and the email may be sent to the user. In other embodiments, the one or more additional deals and/or advertisements may be presented to the user in the user's browser application. For example, the advertisements may be served to the user in the browser application when the user visits other websites.

In accordance with exemplary embodiments, if a user clicks on a deal (e.g., clicks on a link) received in an email, it may be inferred that the user's interest/commercial intent is strong. This intent may be leveraged together with automatically extracted deal information to deliver better deals to the user either by email or via advertisements.

In some embodiments, the user clicking on a “Compare Deals” link, advantageously allows deals aggregators (e.g., deals.yahoo.com) to distribute deals via email without spamming users because clicking of the “Compare Deals” link is initiated by user, and thus implies the user's interest in the deal.

In some embodiments, capturing user's interactions with deals received via emails (both clicks on “View This Deal” link or on the “Compare Deals” link) allows creation of user segments for use in behavioral targeting by advertisers.

While the invention is described with reference to the above drawings, the drawings are intended to be illustrative, and the invention contemplates other embodiments within the spirit of the invention.

1. A method comprising:
using one or more computers, detecting if an email addressed to a user comprises deal information related to one or more deals;
using one or more computers, extracting the deal information if the email is detected to comprise deal information;
using one or more computers, displaying a link in the email upon the user opening the email, wherein the link is configured such that, upon the user clicking the link, a search query comprising the extracted deal information is transmitted to a deal service, and the user's browser application is directed to the deal service.

2. The method of claim 1, wherein the deal service is a deal comparison service configured to retrieve similar or related deals to the one or more deals based at least in part on the extracted deal information.

3. The method of claim 1, wherein the deal service is a search engine configured to retrieve similar or related deals to the one or more deals based at least in part on the extracted deal information.

4. The method of claim 1, wherein the deal information comprises one or more of location information, merchant information, price information, discount information and information related to a type of product or service advertised in the one or more deals.

5. The method of claim 1, wherein the link is a graphical link.

6. The method of claim 1, wherein extracting the deal information comprises extracting the deal information when the email is received by the user's inbox.

7. The method of claim 1, further comprising:
using one or more computers, flagging the email if the email is detected to comprise deal information.

8. The method of claim 1, wherein the deal service is configured to aggregate extracted deal information received from users, and to include deals corresponding to the aggregated extracted deal information in search results.

9. The method of claim 1, further comprising:
using one or more computers, allowing the user to modify one or more parameters of the search query.

10. A system comprising:
one or more server computers coupled to a network; and
one or more databases coupled to the one or more server computers;
wherein the one or more server computers are for:
detecting if an email addressed to a user comprises deal information related to one or more deals;
extracting the deal information if the email is detected to comprise deal information;
displaying a link in the email when the user opens the email; and
the link being configured such that, upon the user clicking the link, a search query comprising the extracted deal information is transmitted to a deal service, and the user's browser application is directed to the deal service.

11. The system of claim 10, wherein the deal service is a deal comparison service configured to retrieve similar or related deals to the one or more deals based at least in part on the extracted deal information.

12. The system of claim 10, wherein the deal service is a search engine configured to retrieve similar or related deals to the one or more deals based at least in part on the extracted deal information.

13. The system of claim 10, wherein the extracted deal information comprises one or more of location information, merchant information, price information, discount information and information related to a type of product or service advertised in the one or more deals.

14. The system of claim 10, wherein the link is a graphical link.

15. The system of claim 10, wherein extracting the deal information comprises extracting the deal information when the email is received by the user's inbox.

16. The system of claim 10, wherein the one or more server computers are further configured for:
flagging the email if the email is detected to comprise deal information.

17. The system of claim 10, wherein the deal service is configured to aggregate extracted deal information received from users, and to include deals corresponding to the aggregated extracted deal information in search results.

18. The system of claim 10, wherein the one or more server computers are further configured for:
allowing the user to modify one or more parameters of the search query.

19. The system of claim 10, wherein the link is overlaid on top of the email.

20. A computer readable medium or media containing instructions for executing a method comprising:
using one or more computers, detecting if an email addressed to a user comprises deal information related to one or more deals;
using one or more computers, flagging the email if the email is detected to comprise deal information;
using one or more computers, extracting the deal information from the email when the email is received by the user's inbox if the email is detected to comprise deal information;
using one or more computers, overlaying a link on top of the email when the user opens the email; and
the link being configured such that, upon the user clicking the link, a search query comprising the extracted deal information is transmitted to a deal service, and the user's browser application is directed to the deal service.
